(19) United States
(12) Patent Application Publication
(10) Pub. No.: US 2007/0294297 A1
(43) Pub. Date: Dec. 20, 2007

(54) Structured playlists and user interface

(76) Inventors: Lawrence Kesteloot, San Francisco, CA (US); Paul Rechsteiner, Toronto (CA); Patti Lorin, San Carlos, CA (US)

Correspondence Address: SWERNOFSKY LAW GROUP PC, P.O. BOX 390013, MOUNTAIN VIEW, CA, 94039-0013, US

(21) Appl. No.: 11/471,014

(22) Filed: Jun. 19, 2006

(51) Int. Cl. G06F 17/00

(52) U.S. Cl. 707/104.1

(57) ABSTRACT

A user interface distinguishes between individual songs and collections of songs. A listener might review or manipulate individual songs, collections thereof, or individual songs within those collections. Review and manipulation includes visualizing those songs and collections queued for play, selecting either individual songs or collections thereof for listening, and selecting individual songs within collections thereof without having to manipulate the entire collection thereof. The user interface includes a visualization of songs queued for play, the visualization including a single block for each individual song and a single block for each collection of songs.

### BACKGROUND OF THE INVENTION

A first known issue in playing songs, whether in public for an audience or in private at home, is selecting the set of songs to be played (sometimes referred to herein as a playlist). Individual songs are relatively short, while listeners generally wish to listen to those songs continuously and relatively passively, without devoting a great deal of attention to the task of selecting songs to be played. A contrasting issue is that listeners simultaneously do wish to have some control over their upcoming playlists, i.e., they wish to be able to make, review and manipulate those playlists, and they wish to have this control without substantial complexity.

A second known issue is that each song might be packaged, sold, bought, and owned, either as an individual song, as a song in a collection, or as both. Listeners who wish to use, review or manipulate their playlists thus are faced with the relative complexity of selecting songs both as individual items and as parts of collections. This can be needlessly complex, and can result in listeners having to devote more attention to reviewing or manipulating their playlists than they would otherwise prefer.

### SUMMARY OF THE INVENTION

The invention includes techniques for listeners to make and to use playlists, including structured playlists as they are defined herein.

In one aspect, the invention allows playlists to be composed of both individual songs and collections of songs, and distinguishes between individual songs and collections of songs, with the effect that a listener might use, review or manipulate playlists or portions thereof (thus being capable of using or reviewing individual songs, collections of songs, or individual songs within those collections of songs; and thus being capable of altering those playlists or portions thereof). In one aspect, the invention includes a user interface in which the listener (or other user) can easily visualize those individual songs and collections of songs in a playlist and easily select individual songs within a collection of songs without losing sight of the integrity of that collection of songs.

In a preferred embodiment, the user interface includes a visualization of differentiated sequential blocks of those songs in a playlist, the visualization including a single block for each individual song and a single block for each collection of songs. This has the effect that the listener can easily distinguish those songs which have been selected individually from those songs which have been selected as part of a collection, while still allowing the listener the ability to investigate information about the songs in each collection.

In a preferred embodiment, the listener can also select one or more individual songs from a collection to be played individually, without having to select the entire collection to be played.

In a preferred embodiment, representations of playlists, and playlist elements, might include text or images from a set of metadata about songs in those playlists or playlist elements. That metadata might be maintained in a local database, an external database, or might be obtained dynamically as convenient for presentation.

### BRIEF DESCRIPTION OF THE DRAWINGS

FIG. 1 shows a block diagram of a system capable of presenting a user interface for reviewing and manipulating structured playlists.

FIG. 2 shows a set of screen elements in a user interface for reviewing and manipulating structured playlists.

FIG. 3 shows a conceptual diagram of a structured playlist.

FIG. 4 (collectively including FIG. 4A, FIG. 4B, and FIG. 4C) shows a set of process flow diagrams showing methods relating to the presentation of a user interface for using structured playlists.

### GENERALITY OF THE DESCRIPTION

This application should be read in the most general possible form. This includes, without limitation, the following:
References to specific structures or techniques include alternative and more general structures or techniques, especially when discussing aspects of the invention, or how the invention might be made or used.
References to “preferred” structures or techniques generally mean that the inventor(s) contemplate using those structures or techniques, and think they are best for the intended application. This does not exclude other structures or techniques for the invention, and does not mean that the preferred structures or techniques would necessarily be preferred in all circumstances.
References to first contemplated causes and effects for some implementations do not preclude other causes or effects that might occur in other implementations, even if completely contrary, where circumstances would indicate that the first contemplated causes and effects would not be as determinative of the structures or techniques to be selected for actual use.
References to first reasons for using particular structures or techniques do not preclude other reasons or other structures or techniques, even if completely contrary, where circumstances would indicate that the first reasons and structures or techniques are not as compelling. In general, the invention includes those other reasons or other structures or techniques, especially where circumstances indicate they would achieve the same effect or purpose as the first reasons or structures or techniques.

After reading this application, those skilled in the art would see the generality of this description.

### Definitions

The general meaning of each of these following terms is intended to be illustrative and in no way limiting.
The phrase “playlist”, and the like, when not qualified as “structured playlist”, denotes any collection of songs, not necessarily in any order.
The phrase “mix album”, and the like, denotes any collection of particularly selected songs, not necessarily in any order, whether commercial or personal. Examples of mix albums might include (1) a set of songs selected by a listener because that listener likes those songs, (2) a set of songs selected by a listener or publisher because that selecting entity believes those songs would be popular as dance music or at a party, (3) a set of songs selected by a listener or publisher to represent a particular artistic form, such as for an academic paper or other exposition, (4) a set of songs selected by a publisher as “mood music” for play at a commercial establishment to encourage customers to enjoy being there.
The phrase “structured playlist” and the like, might include any ordered combination of individual songs, collections of songs, and the like. See FIG. 3 for a conceptual description of this definition. A structured playlist determines a sequence of songs the listener has played, is playing, or intends to play. For some examples, a structured playlist might include one or more of, or some combination of, the following:
   An individual sound track of a song (e.g., a rendition of Poisoning Pigeons in the Park, by the famous Harvard mathematics professor Tom Lehrer);
   An album including several songs, originally published as a unified collection (e.g., all songs from the album The Wall, by the group Pink Floyd);
   A collection of songs from an episode of a television show or movie (e.g., all songs from the movie Sweet Home Alabama);
   A collection of collections of songs, (e.g., a collection of albums by the group Pink Floyd);
   A collection of songs filtered as a subset of a larger collection, all having a common set of defined properties (e.g., all songs from the series Star Trek sung by the character “Lt. Data”, or alternatively, all songs by “Weird Al” Yankovic paired with the songs that inspired them);
   An ordered collection of songs obtained from some first collection of songs by changing only the order of the first collection;
   A collection composed of both individual songs and other collections of songs (e.g., the next two songs as well as the next two albums that a listener chooses to play).
The phrase “sound sequence”, and the like, and the term “song”, and the like, are intended to encompass the same or similar broad scopes. A sound sequence might include any combination of media capable of being presented by the system. This might include one or more of, or some combination of, the following:
   music (regardless of genre, including any song, lyrics, or instrumental recorded commercially or otherwise);
   comedy routines, monologues, speeches, sound tracks from movies, and the like;
   lighting changes (sunrises, sunsets, raising the level of light to compensate for dusk or to simulate sunrise as a form of alarm clock, “disco music” dancing lights, and the like); or
   background and other sound-effects noises (e.g., crowds to simulate attendance at a sports event, office equipment to simulate a work environment for those with home offices, and the like).
   pictoral representations, whether still or moving, such as slides, slide shows, photographs, panoramic photographs, motion pictures, interactive motion pictures, video games, video game “attract mode” formats, motion picture bookmarks, motion picture loops, animations, annotated pictoral representations, virtual reality environments, control signals (without any limitation imposed by human senses), and the like.
The phrase “media item”, and the like, is intended to encompass any presentation, or combination thereof, capable of being discerned by the listener. Note that the “listener” is not necessarily one or more human beings. Accordingly, a media item might include electromagnetic signals, sonic or other pressure signals, haptic or aromatic signals, or any type of physical change discernable by sensors, living or otherwise.
The terms “listener”, and the like, and the term “user”, and the like, are intended to encompass the same or similar broad scopes. However, in the context of the invention, there is no particular requirement to limit the scope of use of the invention to only audio. A user of the system refers to an individual person, or a set of persons, with access to a set of controls for viewing and manipulating an interface associated with the system. However, a user of the system might refer to a controlling program, such as a programmable timer system or a remote device (for when the user wishes to control the system on the way home from work), or might even refer to an Artificial Intelligence program or another substitute for actual human control.

The scope and spirit of the invention is not limited to any of these definitions, or to specific examples mentioned therein, but is intended to include the most general concepts embodied by these and other terms.

### System Elements

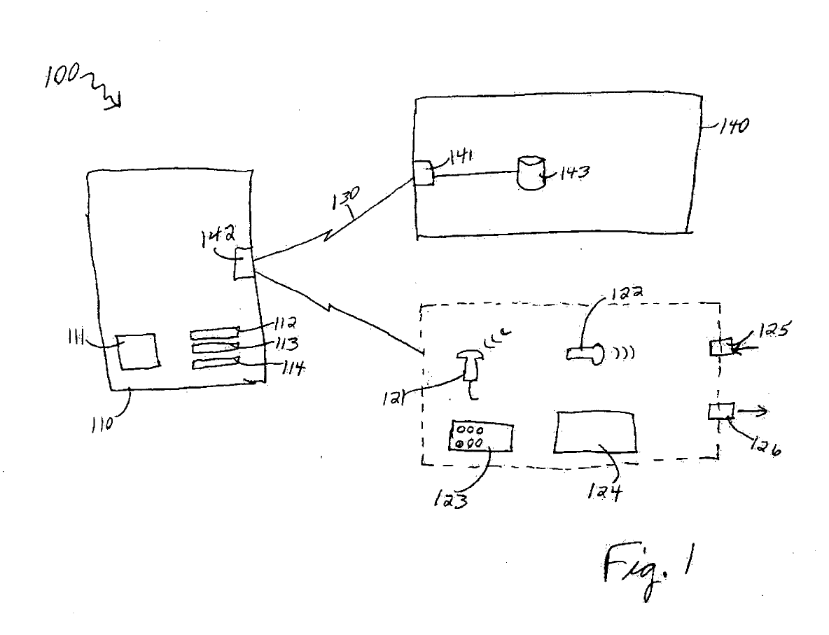

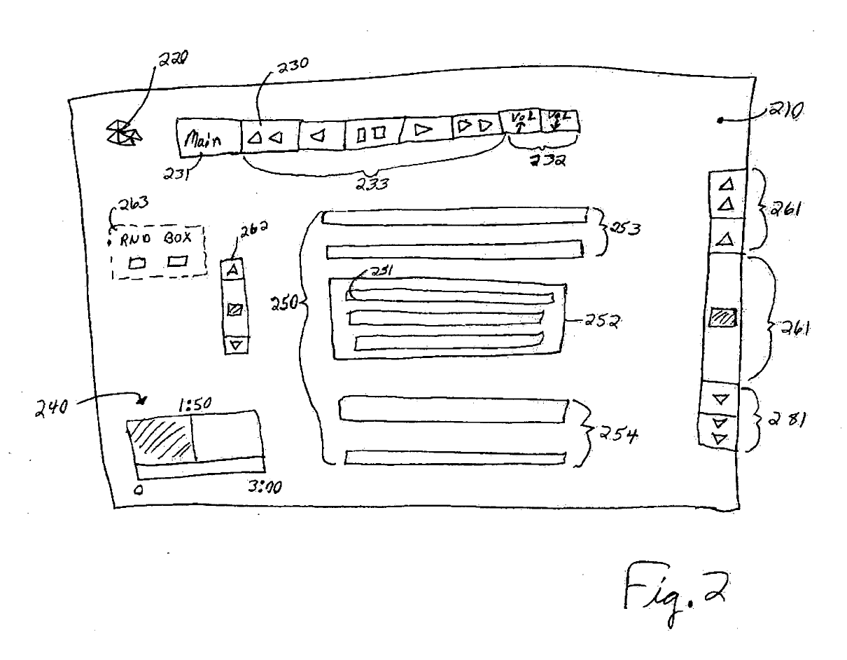

FIG. 1 shows a block diagram of a system capable of presenting a user interface for reviewing and manipulating structured playlists.

### Computing Device

A system 100 includes elements shown in the figure, including at least the following:

| A computing device 110 | A set of input/output elements |
|---|---|
| | 120 |
| A communication link 130 | An (optional) metadata database |
| | 140 |

In a preferred embodiment, a major physical portion of the system 100 would be located in, or coupled to, a home theater or other home entertainment system. This would include at least the computing device 110, the input/output elements 120, and at least part of the communication link 130.

The computing device 110 includes elements shown in the figure, including at least the following:

| | |
|---|---|
| A computing element 111 - including | A first set of instructions 112 - |
| processor, memory, and | relating to presenting a set of |
| mass storage | screen elements in a user interface |
| A second set of instructions 113 - | A third set of instructions 114 - |
| relating to presenting the | relating to making a structured |
| visualization of a structured playlist | playlist |

The computing element 111 includes a processor, memory, and mass storage, configured as in a known desktop, laptop, or server device. In a preferred embodiment, the mass storage might include both attached mass storage, such as a hard disk drive, and removable mass storage, such as a CD or DVD reader or writer. However, in the context of the invention, there is no particular requirement that the computing element 111 include those elements, so long as the computing element 111 is capable of performing the maintaining its state as described herein, and performing the method steps described herein. For a first example, there is no particular requirement that the computing element 111 include any particular form of mass storage, although the inventors expect that a preferred embodiment will include both forms of mass storage described above. For a second example, there is no particular requirement that the computing element 111 is structured as a deterministic device—nondeterministic devices, such as including parallel processing devices, would work as well.

In the context of the invention, there is no particular requirement that the computing element 111 be configured as in a known desktop, laptop, or server device. For several alternative examples, the computing element 111 might be configured as in a cellular telephone, a hand-held audio or video player, a hand-held computing device, a heads-up display device for spectacles or contact lenses, a one-way or two-way “Dick Tracy” communication wristwatch, a PDA, a sub-notebook, an ear-bud audio device, an iPod or equivalent device, and the like. After reading this application, those skilled in the art would recognize that the nature of the invention is broad enough to include, within its scope and spirit, virtually any form of input or output hardware or software, having a user interface as described herein.

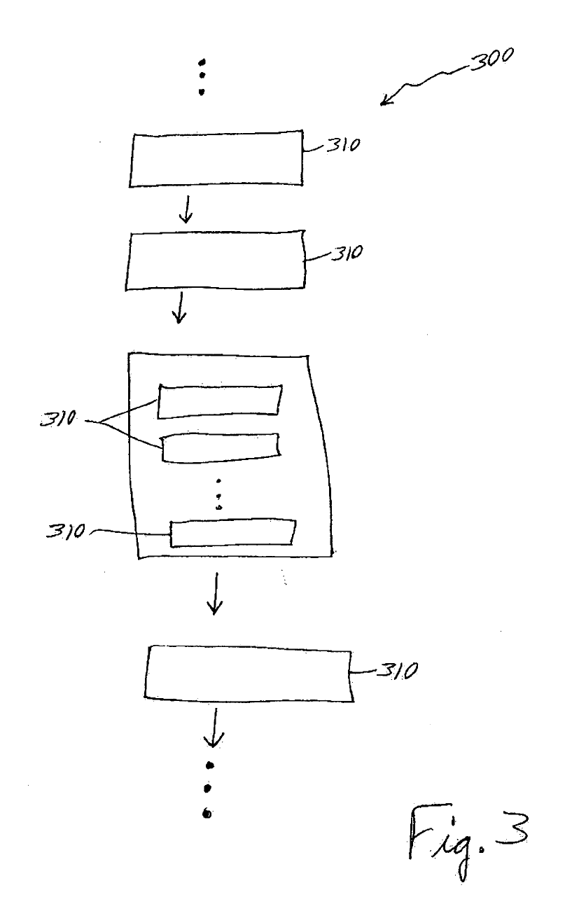

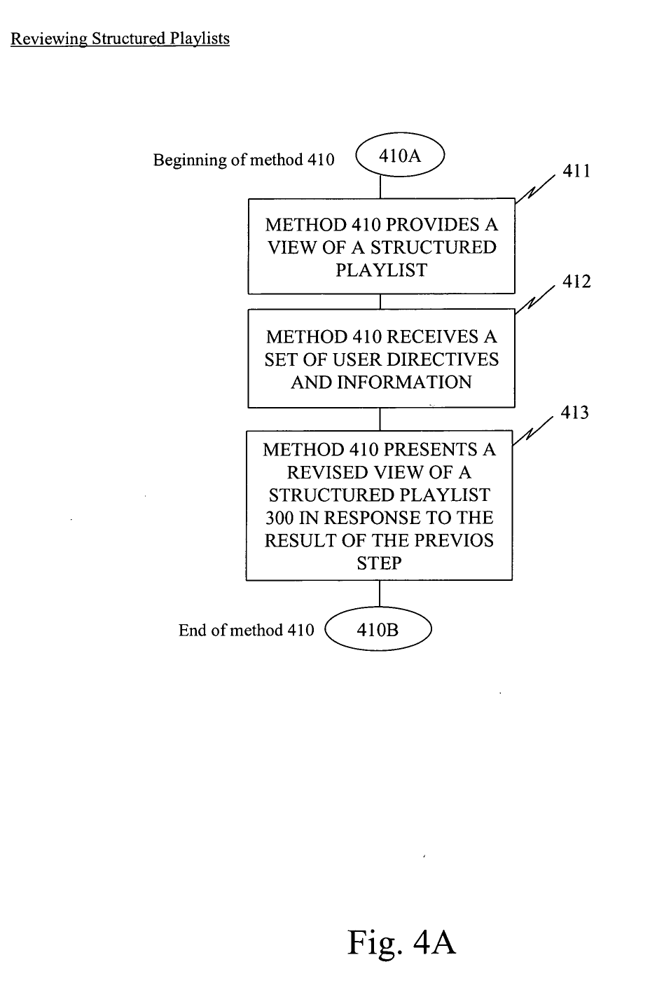

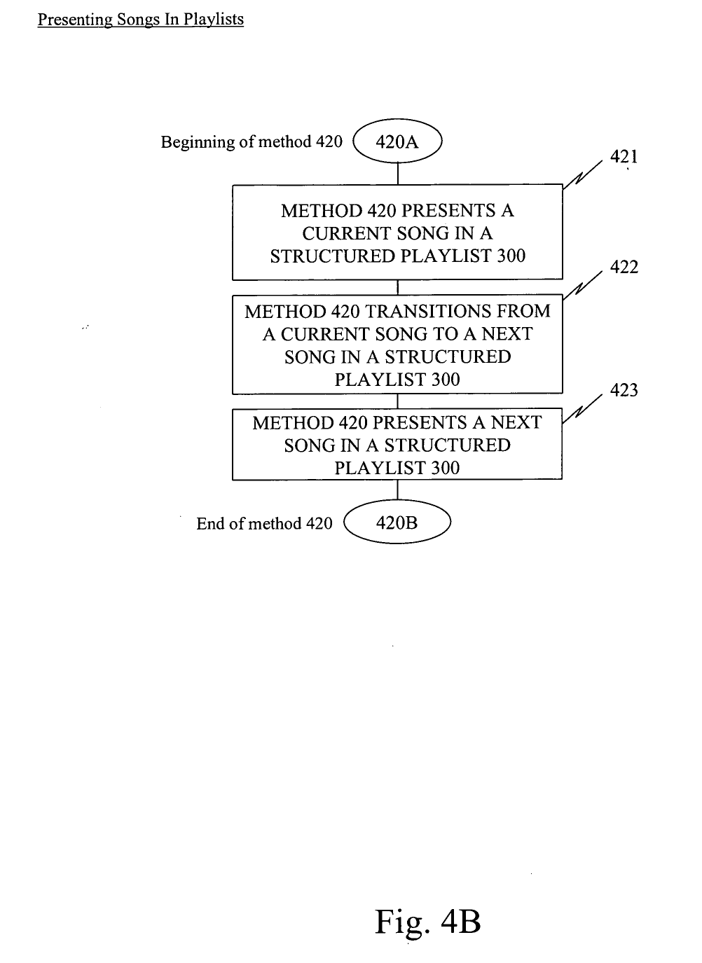

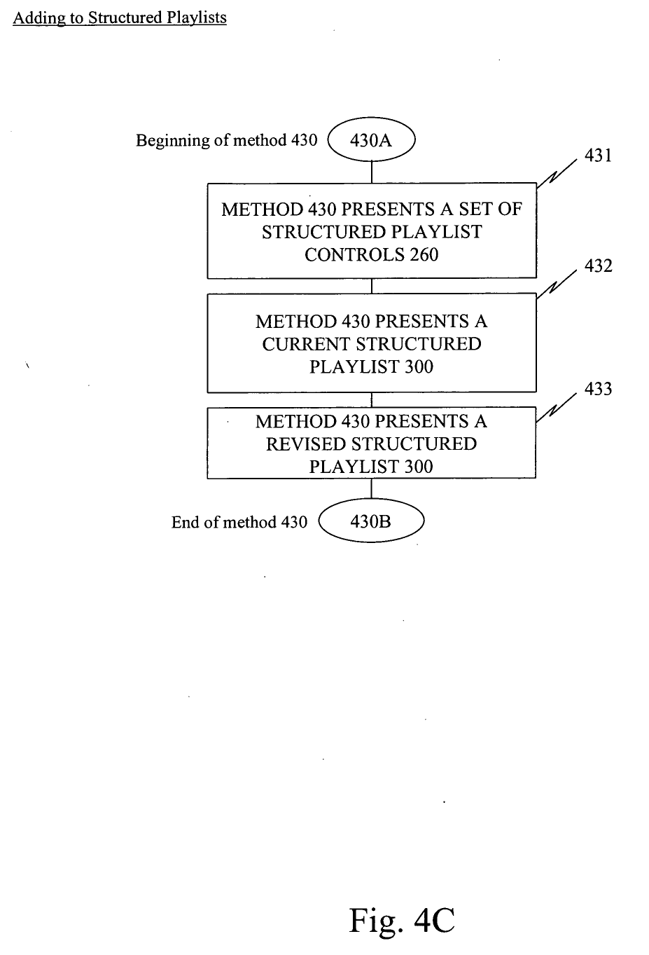

The first set of instructions 112 are interpretable by the computing device 110, and relate to presenting a set of screen elements in a user interface. Techniques for doing so are described below with respect to FIG. 2 and FIG. 4A.

The second set of instructions 113 are interpretable by the computing device 110, and relate to presenting the visualization of a structured playlist. Techniques for doing so are described below with respect to FIG. 2 and FIG. 4B.

The third set of instructions 114 are interpretable by the computing device 110, and relate to making, reviewing, and manipulating a structured playlist. Techniques for doing so are described below with respect to FIG. 4C.

### Input/Output Devices

The input/output elements 120 include elements shown in the figure, including at least the following:

| | |
|---|---|
| A sound sequence input 121 | A sound sequence output 122 |
| A user directives and information | A user directives and information |
| input 123 | output 124 |
| An external messages input 125 | An external messages output 126 |

In a preferred embodiment, the sound sequence input 121 might include a reader for any particular physical medium on which sound sequences can be stored, such as CD, DVD, or a set of memory or mass storage (e.g., in the latter case, hard disk drives). In alternative embodiments, the sound sequence input 121 may in addition or instead include a receiver for any particular communication of sound sequences, such as a radio, television, or computer network input. In the context of the invention, there is no particular requirement for any individual choice of physical devices for the sound sequence input 121, so long as the computing device 110 is capable of maintaining the information, and performing the methods, as described herein, with respect to those sound sequences. As noted above, in a preferred embodiment, the sound sequence input 121 might be included in a home theater or home entertainment system.

In a preferred embodiment, a home theater or home entertainment system includes the sound sequence output 122. In the context of the invention, there is no particular requirement for the physical construction of the sound sequence output 122, so long as the computing device 110 is capable of presenting sound sequences to the user.

In a preferred embodiment, the user directives and information input 123 might include a user input of any type coupled to the computing device 110, and is capable of receiving messages from the user on behalf of the computing device 110. For example, the user directives and information input 123 might include a touch panel screen, a keyboard, a pointing device, or a remote control such as used for viewing television or movies.

In a preferred embodiment, the user directives and information output 124 might include a user output of any type coupled to the computing device 110, and is capable of sending messages to the user on behalf of the computing device 110, e.g., as part of a user interface. For example, the user directives and information output 124 might include any hardware devices for presenting visual screen elements, such as a flat panel screen or a touch panel screen. In a preferred embodiment, the output device 124 is capable of presenting the screen elements in the user interface for using playlists (see FIG. 2 below).

In the context of the invention, there is no particular requirement that either the information input 123 or the information output 124 comprise only a single device. In alternative embodiments, either one or both might include multiple such devices. For one example, the information input 123 might include more than one device, operating in conjunction to provide a combined set of input information. For another example, the information input 123 might again include more than one device, operating instead with distinct degrees of priority, with the effect that one such device might override commands or other input from another. Similarly, the information output 124 might include multiple user interfaces. For one example, the information output 124 might include more than one device, operating in conjunction to provide a combined set of output information; for another example, the information output 124 might include more than one device, operating instead with distinct degrees of priority, with the effect that one user interface might override presentation or other information sent to another.

In the context of the invention, there is no particular requirement that either the information input 123 or the information output 124 include a flat panel screen or a touch panel screen.

For some examples, the information input 123 might receive information from the listener by a wide variety of other techniques, including one or more of:
using a gesturing device, such as used with the Nintendo “Wii” device;
using a keyboard;
using a motion detector (including the possibility of detecting pointing by the listener, detecting simulated typing by the listener as if on a keyboard, or detecting generalized gestures by the listener);
using a pointing device;
using a television “remote” controller (regardless of whether the communication between the remote and the system uses electromagnetic signals in the radio, infrared, visible spectra, or otherwise, or whether that communication uses sonic signals in an audio or ultrasonic band, or otherwise, or whether that remote is coupled to the system using another technique);
using a voice recognition or other sound-recognition device.

Similarly, for some examples, the information output 124 might provide information to the listener by a wide variety of other techniques, including one or more of:
a 2D visual display, such as a CRT display, LCD display, television set, monitor, screen projection device, plasma panel device, and the like;
a 3D visual display, whether physically 3D (e.g., a 3D hologram) or a simulated version of 3D (e.g., a 2D presentation including perspective and overlap) device;
a haptic device (i.e., a motion-producing device), such as a device for buzzing or for shaking the listener's chair;
a printing device;
a set of multiple output devices, such as more than one display screen arranged to present an output in a visually appealing way;
a speaker or other sonic output device.

In a preferred embodiment, a single hardware device might include both the user directives and information input 123 and output 124. For example, a touch panel screen can both receive input from the user and send visual messages to the user.

In the context of the invention, there is no particular requirement that either the information input 123 or the information output 124 are hardware devices or have specific hardware interfaces. For example, the information output 124 might include a server for an HTTP protocol (or one like it, such as SHTTP), and might be accessed using any web browser, FTP client, WSDL application, and the like.

In a preferred embodiment, the external messages input 125 might include an input of any type coupled to the computing device 110, and is capable of receiving external messages on behalf of the user. For example, the user command input 125 might include a connection to the Internet.

In a preferred embodiment, the external messages output 126 might include an output of any type coupled to the computing device 110, and is capable of sending external messages on behalf of the user. For example, the user command output 126 might include a connection to the Internet.

### Communication Link

The communication link 130 is coupled to the computing device 110, at a first end, and to an external communication network, such as the Internet, at a second end. In a preferred embodiment, the communication link 130 transfers messages between the computing device 110 and any external devices with which the computing device 110 communicates, including the (optional) metadata database 140.

### Metadata Database

In a preferred embodiment, the system 100 includes an (optional) metadata database 140. The metadata database 140 includes elements as shown in the figure, including at least the following:

| | |
|---|---|
| A database interface 141 | An (optional) cache of stored |
| | metadata 142 |
| A set of stored metadata 143 | |

In a preferred embodiment, the system 100 would obtain information, including metadata about songs and playlist elements, from the stored metadata 143, using the database interface 141. The database interface 141 might be as simple as a memory register (with the database 140 accordingly being as simple as a reserved location in a memory), or might be a more complex element, such as a client/server query-and-response technique (with the database 140 accordingly possibly being a more complex element, such as an SQL database).

In a preferred embodiment, the system 100 would cache at least some information from the database 140 for rapid reference, particularly if the stored metadata 143 is located at a relative distance or using the technique in which there is a relative cost to re-obtain that information. In some embodiments, the system 100 might maintain a cache 142 of stored metadata for those playlists and playlist elements currently being presented, or about to be presented, to a listener.

In a preferred embodiment, the metadata database 140 might include a relatively remote set of stored metadata 143, such as maintained using mass storage on a logically or physically remote server. However, in the context of the invention, there is no particular requirement that stored metadata 143 is remote. In some alternative embodiments, the system 100 may include a relatively complete set of metadata for all songs in the listener's library, downloaded or otherwise maintained in storage for those songs when those songs are incorporated into that library. In some other alternative embodiments, the system 100 may dynamically generate metadata in response to information available from the song itself.

As described in further detail below, metadata associated with each song might include the artist, associated other titles, cover art, genre, physical box of originating media, physical side of originating media, publisher, song length, title, track location or track number, year of release, and the like, as well as any other information convenient or useful for identifying songs besides actually listening to them.

### User Interface

FIG. 2 shows a set of screen elements in a user interface for reviewing and manipulating structured playlists.

### Screen Elements

A user interface 200 includes elements shown in the figure, including at least the following:

| An active portion 210 of the | An (optional) set of descriptive |
|---|---|
| screen | system information 220 (e.g., a |
| | logo) |
| A set of generic menus 230 - of | A set of song play information 240 |
| general value in playing sound | (e.g., duration, volume, and the |
| sequences | like) |
| A set of structured playlist | A set of structured playlist controls |
| information 250 | 260 |

An active portion 210 of the screen includes a region selected for use by the user interface 200. In a preferred embodiment, the active portion 210 includes as much of the screen as can be allocated to the user interface 200. In a preferred embodiment in which the system 100 is embodied in a home theater or home entertainment system, the active portion 210 includes substantially all the screen.

An (optional) set of descriptive system information 220 (e.g., a logo) includes information of descriptive interest to the user, but not necessarily of specific functional use as part of the user interface 200. In a preferred embodiment, the set of descriptive system information 220 includes a logo for Kaleidescape™, a manufacturer of the system with an office in Mountain View and assignee of this application.

A set of generic menus 230 includes a set of controls that might be manipulated by the user to effect functions of generic value in playing sound sequences. In a preferred embodiment, these might include one or more of the following:
A main menu 231 or other interface to the system 100, including a set of controls that might be manipulated by the user to effect functions provided by the system 100, such as turning off the whole system.
A set of sound controls 232 or other interface to the sound sequence output 122, including a set of controls that might be manipulated by the user to effect functions such as control of volume, balance, speaker selection, individual presentation device control, parental restrictions on individual presentation devices, and the like.
A set of song play controls 233 that might be manipulated by the user to effect functions commonly available with CD and DVD players. Examples include functions to play, restart, rewind, back up, pause, continue, skip forward, fast forward, and stop playing.

A set of song play information 240 (e.g., dynamic sound frequency, duration, volume, bitrate of data encoding, any other information relating to performance aspects of the song, and the like) includes information relating to how much time a song will take to play, how long the song has been playing and what percentage of it has been played, and how long the song has left to play and what percentage of it has yet to be played. In a preferred embodiment, this information is updated frequently, with the visual effect that a progress bar changes color over time from the beginning to the end of the song.

A set of structured playlist information 250 includes a list of those songs and those collections of songs that have (1) been played so far, (2) are currently playing, and (3) are queued for future play. In a preferred embodiment, this information is updated at the beginning of each played song so that the designation of queued songs and playlist elements as past, current, or future is accurate.

Metadata

In a preferred embodiment, metadata associated with each song might include the artist, associated other titles, cover art, genre, physical box of originating media, physical side of originating media, publisher, song length, title, track location or track number, year of release, and the like, and one or more of the following:
A set of current song information 251;
A set of current structured playlist element information 252;
A set of past structured playlist element(s) information 253;
A set of future structured playlist element(s) information 254;
A set of text or images, or both, from an optional metadata database 140.

In a preferred embodiment, each element in a structured playlist is included within one of the current 252, future 253 or past 254 structured playlist information sets. Each structured playlist element includes information sufficient for the user to refer to it. If that element is a collection of songs, then the information may include descriptive information about the collection, e.g., album artist, title and cover art, or a description of a filter rule selecting that collection. In a preferred embodiment, the current song information 251 includes information sufficient for the user to refer to it, e.g., song artist, title and corresponding cover art.

The structured playlist information 250 is also described in further detail below.

Structured Playlist Controls

A set of structured playlist controls 260 includes a set of controls that might be manipulated by the user to effect functions relating to changing the visualization of the structured playlist information 250, playing songs in structured playlists, and changing the structure of a structured playlist. In a preferred embodiment, this might include one or more of the following:
A set of screen scrolling controls 261 (e.g., to top of scrollable information, scroll up one screen, scroll up one line or paragraph, scroll down one line or paragraph, scroll down one screen, scroll to end of scrollable information, scroll to left of scrollable information, scroll left one screen, scroll left one line or paragraph, scroll right one line or paragraph, scroll right one screen, scroll to right of scrollable information, and the like), including a set of controls that might be manipulated by the user to effect those functions.
A set of structured playlist scrolling controls 262 (e.g., scroll to beginning of structured playlist, scroll up one element, select element or elements, scroll down one element, scroll to end of structured playlist, and the like), including a set of controls that might be manipulated by the user to effect those functions.
A set of structured playlist play controls 263 (e.g., play selected songs in sequence, play one song repeatedly, play selected songs repeatedly, play randomly from among an entire structured playlist, play randomly from among a designated portion of a structured playlist, and the like), including a set of controls that might be manipulated by the user to effect those functions.
In the context of the invention, the structured playlist controls 263 are not limited to any particular playlist element, and might include controls that include multiple playlist elements in combination or conjunction (e.g., “jump to” the beginning of the current playlist element, “repeat playing” the entire current playlist element, “jump to” the next playlist element, “jump to” a particular playlist element among the past or future playlist elements, “jump to” a particular subelement in the next playlist element, “repeat a set” of selected playlist elements “randomly”, “repeat a set” of selected playlist elements “in sequence”, and the like).
A set of structured playlist manipulation controls 264 (e.g., remove, add, replace, or insert designated structured playlist elements, and the like), including a set of controls that might be manipulated by the user to effect those functions.

In a preferred embodiment, a representation of the structured playlist is responsive to an ordering of those elements of the structured playlist selected for performance. For example, it might occur, either because the listener has selected songs to be played in a particular order, or because the listener has selected songs to be played randomly, that a representation of the next song is not available within the active screen. In such cases, the system 100 scrolls, slides, or otherwise alters its presentation of the structured playlist so that the next song becomes available within the active screen. This might cause other songs to be become unavailable. In embodiments where the system 100 scrolls or slides between the most recent song and the next song, those songs which are intermediate are represented, however briefly, while the scrolling or sliding is performed.

After reading this application, those skilled in the art would recognize that this scrolling or sliding technique is applicable independently of the nature of the presentation of the song, whether that representation is text, a simple icon, a pictoral element, a cover art element, and the like. Similarly, this scrolling or sliding technique is also applicable if the song to be performed is in fact a visual performance, such as a slide, a slide show, a motion picture, an animation, and the like.

The structured playlist controls 260 are also described in further detail below.

### Structured Playlist Information and Controls

In a preferred embodiment, the structured playlist information 250 and the structured playlist controls 260 are presented in a designated portion of the screen.

As described above, the structured playlist information 250 includes information regarding a set of songs or collections of songs. The designated portion represents each structured playlist element, whether an individual song or a collection of songs, as an individual frame within that designated region.

This has the effect that the designated portion represents the structured playlist information 250 as a sequence of frames, each frame indicated as being separate from the others. In a preferred embodiment, each frame is separated from its neighboring frames by a separator, and the frames are disposed in an order with top-to-bottom representing past-to-future selections. However, in the context of the invention, there is no particular requirement for this particular ordering; the scope and spirit of the invention allows for a large set of possibilities, of which this is only one example.

2D and Other Nonlinear Formats

In some embodiments, frames (either within a playlist or otherwise) might be disposed in a 2D format, such as for example a 2×2 array or a 2×3 array of playlist elements, or even a non-rectilinear arrangement such as a 2-3-2 hexagonal arrangement. As described below, the frame representing the current structured playlist element may have a graphic design that clearly distinguishes it among the sequence of frames.

It might occur that not all song icons of the current structured playlist element would fit into the 2D formatted array. In such cases, the system 100 might select, in addition or in lieu of distinguishing the current structured playlist element, to rearrange the song icons to place the current song icon in a particular position within the 2D formatted array (such as, the upper left corner). The system 100 might also select, in addition or in lieu of distinguishing the current structured playlist element, to re-select a new set of song icons to represent the current structured playlist.

In a preferred embodiment using such techniques, the system 100 uses a 2×2 or 2×3 array, highlights the current structured playlist element, and pseudo-randomly selects one or two of the selected song icons, other than the song icon for the “next” song, to be changed. In such embodiments, the system 100 causes the song icons to be changed to cross-fade, one fading out while the other fades in, using a 6 second linear luminosity cross-fade. In alternative embodiments, the system 100 includes scrolling invocation elements, such as a sliding bar, up/down arrows, and the like, with the effect that the listener might direct the system 100 to present more such song icons not already shown.

In a preferred embodiment using lines of text or similar linear up/down or right/left presentation, the system 100 also includes scrolling invocation elements, with the that the listener might direct the system 100 to present more such song icons not already shown. Those more such song icons might be icons for songs already played, songs scheduled to be played, and the like.

Distinguishing Selected and Playing Songs

In a preferred embodiment, the frame representing the current structured playlist element may have a graphic design (e.g., a distinctive border or a color background) that clearly distinguishes it among the sequence of frames. Moreover, the graphic design, such as the distinctive border or color background, might be distinct in response to the type of the current structured playlist element.
For a first example, in the case that the current structured playlist element includes an album of songs, the distinctive border might include a solid blue hue (or other color, of course) some small number of pixels wide, sufficient to visually distinguish that playlist element to the user.
For a second example, in the case that the current structured playlist element includes a result of filtering a more general playlist element, the distinctive border might include a striped red and yellow hue (or other colors, of course) a similar number of pixels wide, also sufficient to visually distinguish that playlist element to the user, and also sufficient to visually distinguish that playlist element to the user as a different type of structured playlist element.

This has the effect that the user can easily see each separate structured playlist element modeled as a unitary item, while simultaneously allowing the user to easily see the concrete structure of each such separate structured playlist element. In general, the representation of a playlist element might be responsive to its appearance as a physical object, or at least to an iconic object widely representative of that physical object. As described below, single songs might look like single records, albums might look like albums with cover art and track listings and track numbering, mix albums might look like lists. A wide and varied set of distinct representations are possible:
In cases in which a particular structured playlist element includes a collection of songs, the user can easily see at least a portion of that collection of songs.
In cases in which a particular structured playlist element includes a single song, the frame representing that playlist element might include an iconic image of a CD or DVD single, a vinyl single, or an iconic image representing a computer file having data representing that single song.
In cases in which a particular structured playlist element includes an album including multiple songs, the frame representing that playlist element might include a set of cover art for that album (possibly the original cover art, possibly a set of alternative cover art) from physical packaging associated with that album. The frame representing that playlist element might also include track listings, track numbering, and track lengths for the album. Tracks might even be labeled regarding which side they are from, or in the case of albums with multiple physical disks, which physical disk they are from.
In cases in which a particular structured playlist element includes a collection of multiple songs by a particular artist, the frame representing that playlist element might include a set of cover art representative of that artist, such as a illustration, photograph, a glyph (such as in the case of the “artist formerly known as Prince”), and the like.
In cases in which a particular structured playlist element includes a boxed set of multiple albums (or multiple single songs), the frame representing that playlist element might include an image of a 3D box, an collage of images of selected elements in the boxed set, and the like. A set of text or images, or both, from an optional metadata database 140.
A graphic design of one or more presentations of each playlist or playlist element might be responsive to the (optional) metadata database 140. For example, the metadata database 140, in conjunction with demographic information about the listener, might have several visual images to associate with a particular song, of which one or more are selected in response to a theme preferred by the listener.

After reading this application, those skilled in the art would realize that these cases are merely exemplary, and that a wide variety of possibilities remain within the scope and spirit of the invention.

Similarly, this has the effect that the user can easily select each separate structured playlist element as a unitary item, while simultaneously allowing the user to easily select only a portion of a particular structured playlist element as a separate item. For example, in cases in which a particular structured playlist element includes a collection of songs, the user can easily select (1) the entire collection of songs, (2) a particular one or more of that collection, without selecting the entire collection, (3) the entire collection of songs, except for a particular one or more of that collection, e.g., “all songs except these two”.

In a preferred embodiment, in the case that the user selects only a portion of a particular structured playlist element as a separate item, those songs that are selected are presented in a different manner from those songs that are not selected. For one example, in the case in which a particular structured playlist element includes a collection of songs, and the user selects only some of those songs, (1) the song actually being played would be presented in a first manner, e.g., in a highlighted blue background, (2) those selected songs which are not being played would be presented in a second manner, e.g., in an un-highlighted blue background, and (3) those songs which were not selected for play would be presented in a third manner, e.g. in an un-highlighted grayed-out background.

As each current song ends playing, the system starts the next song and alters the status of any relevant structured playlist elements as past, current and future. The method for determining the next song depends on the ordering of the structured playlist and is described in more detail with respect to FIG. 4B.

The structured playlist controls 260 allow the user to change the visualization and structure of the structured playlist, even during play. This has the effect that the user is able to alter the structured playlist information 250, at least as follows:
The user is no longer able to alter the status of the just-ended element (it remains having been played in the past), although the user might delete (or scroll away from) its representation from the list of past elements.
The user is able to alter the status of the just-beginning (and nowplaying) element, such as by halting it, skipping it, removing it from the structured playlist, or moving it to a later position in the structured playlist.
The user is able to alter the status of one or more future elements in the structured playlist, such as by removing them or rearranging them in the structured playlist.

The user is able to alter the status of one or more elements in the structured playlist, such as designating them to be played or designating them not to be played, in the future. In the case that the elements in the structured playlist have been marked for random or pseudo-random play, or for repeated play, that altered status would apply to all songs so marked, either after the current song is completed or immediately (that is, interrupting the current song).
The user is able to add one or more elements to the structured playlist, such as by appending them to the end of the structured playlist, inserting them into a middle position in the structured playlist, or by replacing other elements already scheduled in the structured playlist.

In a preferred embodiment, when the user adds one or more elements to the structured playlist, the user is given at least one of these options:
to append those elements to the end of the structured playlist 300; or
to replace all future elements in the structured playlist 300 with the new (one or more) elements (this is the default case); or
to insert the new (one or more) elements into the structured playlist 300 in a designated position.

Elements Essentially without End

In some embodiments, it might occur that a playlist element is essentially without a definite end, such as in the case that the playlist element is to “repeat this song” indefinitely, or in the case that the playlist element is to “play a random selection from this (very large) collection”. As a typical example, if the listener chooses a playlist element that specifies playing a random item of classical music, this playlist element would be essentially without a definite end, given the very large number of possible classical music selections, and even if the system 100 were to stop that playlist element after having played each classical music element once.

In such embodiments, the listener or the system 100 might provide a number of ways in which the playlist element that is essentially without end would end. Just a few of the many different possibilities are:
The listener or the system 100 might specify a limiting condition, such as when some amount of time, e.g., 300 minutes, or when some number of songs, e.g., 200 songs, have been completed.
The listener or the system 100 might specify an interrupting condition, such as when the listener chooses to manually pause presentation of songs, or when the listener chooses to manually end presentation of that playlist element that is essentially without end.
The listener might choose to manually interrupt the playlist element, with the effect of directing the system 100 to proceed with a next playlist element, a different playlist element specified at that time by the listener, a different playlist element specified at an earlier time by the listener, a different playlist element deduced by the system 100 in response to listener preferences, and the like.
While playlist elements queued after the playlist element that is essentially without end would generally not ever be played, the listener or the system 100 might provide that if there are enough such queued playlist elements, the playlist element that is essentially without end would be artificially ended.
Similarly, while the listener might typically queue playlist elements for presentation after the presently queued set of playlist elements, the listener or the system might provide that if the listener queues a playlist element before the playlist element that is essentially without end, presentation would proceed with that new playlist element queued before the playlist element that is essentially without end, with the effect that the playlist element that is essentially without end would be interrupted to present a different song.
Similarly, the listener might queue playlist elements for performance concurrently with or interleaved with the presently queued set of playlist elements. In such cases, the listener or the system might provide that the listener queues a second set of playlist elements to be performed concurrently with or interleaved with the first playlist element (which is essentially without end), that is, the second set would be interleaved with the first playlist element if they involved the same type of performance (e.g., audio play), or the second set might be either interleaved, or performed concurrently with the first playlist element if they involved distinct types of performance which did not interfere (e.g., audio play with a slide show). For a first example, the listener might choose “play Mozart” as a first playlist element (essentially without end) and “play Brahms” as a second playlist element (also essentially without end), select “random play”, and obtain a random selection of songs from either Mozart or Brahms. For a second example, the listener might choose “play 1960's pop rock” (essentially without end) as a first playlist element and “show slide show of pinup calendar poses” (also possibly essentially without end) as a second playlist element, select “random play”, and obtain a random selection of displayed pinup calendar poses along with 1960's pop rock songs to go with them.

After reading this application, those skilled in the art will recognize that the possibilities for other and further techniques for application to playlist elements that have essentially no definite end are wide and varied. The examples described above are only exemplary and do not limit the scope and spirit of the invention.

After reading this application, those skilled in the art will recognize that application of the user interface 200 to structured playlists 300 is broad and general; The embodiments described above are only exemplary and do not limit the scope and spirit of the invention.

### Structured Playlist

FIG. 3 shows a conceptual diagram of a structured playlist.

A structured playlist 300 (conceptually) includes an ordered list of at least one or more of the following types of list elements:
310, a song;
320, an ordered collection of songs 310.

A structured playlist 300 might include an individual song 310. A structured playlist 300 might include one or more elements 320, each of which includes an ordered collection of songs 310. This has the effect that a structured playlist 300 might include one or more of the following:
A collection of individual songs 310.
A collection of elements, each of which is either an individual song 310 or a collection of individual songs 310.
A collection of songs filtered as a subset of a larger collection, all having a common set of defined properties, where the defined properties are specified by one or more filter specifications.
Similar collections of individual songs 310 and other elements.

After reading this application, those skilled in the art would see that the concept of a structured playlist 300 is quite general, and includes a broad range of possible collections of elements, each either an individual song 310 or a collection 320 thereof.

### Methods of Operation

FIG. 4 (collectively including FIG. 4A, FIG. 4B, and FIG. 4C) shows a set of process flow diagrams showing methods relating to the presentation of a user interface for using structured playlists.

### Visualizing Structured Playlists

A method 410 includes techniques for presenting a visualization of structured playlists. This first method 410 includes flow points and steps shown in the figure, including at least the following:

| | |
|---|---|
| A flow point 410A, defining a | A step 411, providing a visualization |
| beginning of the method 410 | of a structured playlist 300 |
| A step 412, receiving a set of user | A step 413, presenting a revised |
| directives and information | visualization of a structured playlist |
| | 300 |
| A flow point 410B, defining an | |
| end of the method 410 | |

A flow point 410A defines a beginning of the method 410.

At a step 411, the method 410 provides a visualization of a structured playlist, including a set of structured playlist information 250 and a set of structured playlist controls 260 as described above.

A visualization of one or more structured playlists, or particular playlist elements therein, might be responsive to the (optional) metadata database 140. For example, the metadata database 140, in conjunction with demographic information about the listener, might have several visual images to associate with a particular song, of which one or more are selected in response to a theme preferred by the listener.

At a step 412, the method 410 receives a set of user directives and information, as described above with respect to the user directives and information input 123 and the user directives and information output 124. In a preferred embodiment, the user directives and information include one or more of the following:
A set of generic user directives and information, such as those described above with reference to the generic menus 230 (e.g., a main menu 231, a set of sound controls 232, a set of song play controls 233, and the like).
A set of user directives and information regarding structured playlists 300, such as those described above with reference to the structured playlist controls 260 (e.g., a set of screen scrolling controls 261, a set of structured playlist scrolling controls 262, a set of structured playlist play controls 263, a set of structured playlist manipulation controls 264, and the like).

At a step 413, the method 410 presents a revised visualization of a structured playlist 300, in response to a result of the previous step. In a preferred embodiment, the revised visualization includes one or more of the following:
A revised set of current song information 251, as described above.
A revised set of past structured playlist element information 253, as described above.
A revised set of current structured playlist element information 252, as described above.
A revised set of future structured playlist element information 254, as described above.

As noted above, a visualization of one or more structured playlists, or particular playlist elements therein, might be responsive to the (optional) metadata database 140. The revised visualization might similarly be responsive to the (optional) metadata database 140.

A flow point 410B defines an end of the first method 410.

### Presenting Songs in Playlists

A second method 420 includes techniques for presenting songs in playlists. This second method 420 includes flow points and steps shown in the figure, including at least the following:

| | |
|---|---|
| A flow point 420A, defining a | A step 421, presenting a current |
| beginning of the method 420 | song in a structured playlist 300 |
| A step 422, finding a new current | |
| song and a new current structured | |
| playlist element within a | |
| structured playlist 300 | |
| A flow point 420B, defining an | |
| end of the method 420 | |

A flow point 420A defines a beginning of the method 420.

At a step 421, the method 420 presents a current song in a structured playlist 300. As described above, a set of song play information 240 is updated frequently during presentation of the current song.

At a step 422, the method 420 finds a new current song and a new current structured playlist element. In a preferred embodiment, this step includes the following sub-steps:
At a sub-step 422(a), if the current playlist element is a song, then the next structured playlist element (relative to the ordering of the structured playlist) is designated as the new current playlist element.
At a sub-step 422(b), if the new current playlist element is a song then the new current song is that song.
At a sub-step 422(c), if the new current playlist element is a collection of songs, then the new current song is the first song in that collection.
At a sub-step 422(d), if the current playlist element is a collection of songs, the method 400 determines whether there are any songs remaining in that collection to be played.
   If not,—that is, the current song is the last song in the collection—the method 400 designates the next playlist element (relative to the ordering of the structured playlist) as the new current playlist element and determines the new current song as described above.
   If so,—that is, the current song is not the last song in its collection—the method 400 designates the next song (relative to the ordering of the current collection of songs) as the new current song, and the current playlist element remains the same.

As described above, some structured playlist elements will have their status logically altered from future to current and from current to past within the structured playlist information 250.

A flow point 420B defines an end of the second method 420.

### Changing the Structure of Structured Playlists

A third method 430 includes techniques for changing the structure of structured playlists. This third method 430 includes flow points and steps shown in the figure, including at least the following:

| | |
|---|---|
| A flow point 430A, defining a | A step 431, presenting a set of |
| beginning of the method 430 | structured playlist controls 260 |
| A step 432, presenting a current | A step 433, receiving a set of user |
| structured playlist 300 | directives and information. |
| A step 434, presenting a revised | A flow point 430B, defining an |
| structured playlist 300 | end of the method 430 |

A flow point 430A defines a beginning of the method 430.

At a step 431, the method 430 presents a set of structured playlist controls 260, as described above.

At a step 432, the method 430 presents a current structured playlist 300, as described above.

At a step 433, the method receives a set of user directives and information regarding changing the structured playlist. In a preferred embodiment, the user directives and information include one or more of the following:
Deleting a structured playlist element;
Add a new element to the structured playlist in a designated position within the order of the structured playlist;
Changing the ordering of the structured playlist elements;
Replacing a structured playlist element with a new element.

In a preferred embodiment, changes performed requested at this step 433 might be limited by the logical restriction of not changing the structure of elements in the structured playlist that have already been played.

At a step 434, the method 430 presents a revised structured playlist 300, as described above.

A flow point 430B defines an end of the third method 430.

### Generality of the Invention

This invention should be read in the most general possible form. This includes, without limitation, the following possibilities included within the scope of, or enabled by, the invention.

After reading this application, those skilled in the art would see the generality of this application.

### TECHNICAL APPENDICES

This application includes the following technical appendices. These documents form a part of this disclosure, and are hereby incorporated by reference as if fully set forth herein.
Elliott Pearl, Serial Collage (unpublished).
A set of screenshots of a user interface, produced by Elliott Pearl of Kaleidescape, Inc.

1. A method, including steps of
presenting at least a portion of a structured playlist, the structured playlist including a set of playlist elements, each playlist element including at least one of (a) a media item, (b) a collection of media items, wherein those steps of presenting a playlist element are responsive to a type of that playlist element;
performing a set of media items associated with that set of playlist elements, each media item having a status;
altering a status of at least one media item in response to those steps of performing, those steps of presenting being responsive to that status.

2. A method as in claim 1, including steps of
associating the structured playlist with an ordering;
reordering at least a portion of that structured playlist, with the effect that the steps of performing are intended to perform that structured playlist in a changed order.

3. A method as in claim 2, wherein
those steps of presenting include distinctly representing a particular portion of the structured playlist, with the effect that the emphasized portion is more easily noticed.

4. A method as in claim 1, including steps of
changing from a first media item currently being performed to a second media item; and
adjusting a presentation of at least one of the first media item and the second media item in response thereto.

5. A method as in claim 4, including steps of
altering a presentation of at least one of the first media item and the second media item, with the effect that a different one of the first media item and the second media item is emphasized.

6. A method as in claim 4, wherein
those steps of adjusting include moving a presentation of at least one of the first media item and the second media item.

7. A method as in claim 4, wherein
those steps of adjusting include scrolling at least one of the first media item and the second media item within an active screen area.

8. A method as in claim 1, including steps of
inserting at least a portion of a new playlist element into that structured playlist, with the effect that the steps of performing are intended to perform that portion of the new playlist element.

9. A method as in claim 8, wherein the portion of a new playlist element to be inserted includes at least a portion embodied on an external medium.

10. A method as in claim 8, wherein the structured playlist into which that portion of a new playlist element is to be inserted is a null playlist.

11. A method as in claim 1, including steps of
presenting a set of metadata in association with at least one playlist element;
whereby that metadata is associated with one or more media items within that playlist element.

12. A method as in claim 11, wherein those steps of presenting include
presenting a first set of metadata in association with a first playlist element;
presenting a second set of metadata in association with a second playlist element;
wherein metadata selected for that second playlist element differs in type from metadata selected for that first playlist element.

13. A method as in claim 11, wherein those steps of presenting include
presenting a first set of metadata in association with a first playlist element, that first set of metadata being dynamic or static in response to whether that playlist element is currently being performed;
presenting a second set of metadata in association with a second playlist element, that second set of metadata being dynamic or static in response to whether that playlist element is currently being presented.

14. A method as in claim 11, wherein those steps of presenting include
presenting a first set of metadata in association with a first playlist element that is currently being performed, that first set of metadata including at least one type of dynamic information responsive to a progress of performing that first playlist element;
presenting a second set of metadata in association with a second playlist element that is not currently being performed, dynamic information about that second set of metadata responsive to a progress of performing that second playlist element not being substantially presented.

15. A method as in claim 1, including steps of
presenting only a portion of a first structured playlist, that first structured playlist including a plurality of elements; and
altering a presentation of that first structured playlist in response to a selection of a subset of that plurality of elements.

16. A method as in claim 15, wherein
that portion of the first structured playlist substantially fills a portion of an active screen region allocated to that first structured playlist; and
those steps of altering include selection of a distinct portion of that first structured playlist to fill that portion of the active screen region.

17. A method as in claim 15, wherein
those steps of altering including scrolling that presentation to include at least a portion of that selected subset.

18. A method as in claim 1, wherein
at least one of those playlist elements is essentially without a definite end.

19. A method as in claim 18, including steps of
interposing a condition by which at least one playlist element having essentially no definite end is interrupted, paused, or otherwise ended;
wherein that condition operates without substantial overview by a listener.

20. A method as in claim 18, including steps of
interrupting, pausing, or otherwise ending at least one playlist element having essentially no definite end.

21. A method as in claim 1, wherein
those steps of representing a particular playlist element involve a representation substantially distinguishable in response to a type of that particular playlist element.

22. A method as in claim 21, wherein
that representation substantially distinguishes between (a) individual media items, (b) collections of media items.

23. A method as in claim 21, wherein
that representation substantially distinguishes between (a) mix albums, (b) other types of playlist elements.

24. A method as in claim 21, wherein
that representation substantially distinguishes between at least two of (a) individual songs, (b) albums, (c) mix albums, (d) other types of playlist elements.

25. A method as in claim 1, wherein
at least two such media items are discernable using distinct senses.

26. A method as in claim 1, wherein
the presented portion of a structured playlist includes only a portion of at least one selected playlist element.

27. A method as in claim 1, wherein
the presented portion of a structured playlist includes only a selected subset of playlist elements.

28. A method as in claim 1, wherein
that status includes information regarding at least two of: whether media items have been performed, are being performed, or are planned for performance;
at least one playlist element includes a set of media items, of which only a subset of that set are planned for performance; and
those steps of presenting include showing at least some media items included in that playlist element outside that subset.

29. A method as in claim 1, wherein
the structured playlist elements are associated with an ordering;
that status includes information regarding at least two of: whether media items have been performed, are being performed, or are planned for performance;
those steps of presenting include maintaining a status of at least one particular playlist element, and changing that status from those planned for performance to those being performed when that particular playlist element includes a media item that is started.

30. A method as in claim 29, including steps of
altering a location for presentation of that particular playlist element in response to a change in its status.

31. A method as in claim 29, including steps of
altering that ordering of at least a portion of that structured playlist, with the effect that the steps of performing are intended to perform that structured playlist in a changed order.

32. A method as in claim 29, including steps of
in response to a change in status of that particular playlist element, presenting that particular playlist element distinctly from other playlist elements.

33. A method as in claim 29, including steps of
inserting or removing at least a set of playlist elements into that structured playlist, with the effect that the steps of performing are intended to perform an altered version of that structured playlist.

34. A method as in claim 33, wherein
the portion of a new playlist element to be inserted includes at least a portion embodied on an external medium.

35. A method as in claim 33, wherein
the structured playlist into which that set of playlist elements are to be inserted is a null playlist.

36. A method as in claim 29, including steps of
providing an interface for a user to navigate within a structured playlist;
wherein the interface provides steps of changing from a first media item currently being performed to a second media item, and adjusting the status of playlist elements between the first media item and the second media item in response thereto.

37. A method as in claim 36, wherein
the interface includes steps of presenting an indicator of a selectable such second media item.

38. A method as in claim 36, wherein
the interface includes steps of presenting further information about a selectable such second media item.

39. A method as in claim 36, wherein
the interface includes steps of randomly or pseudorandomly selecting each such second media item.

40. A method as in claim 29, wherein
that particular playlist element includes only a portion of a structured playlist to be concurrently presented.

41. A method as in claim 1, wherein
the structured playlist elements are associated with an ordering;
that status includes information regarding at least two of: whether media items have been performed, are being performed, or are planned for performance;
those steps of presenting include retaining a particular playlist element as being performed when that particular playlist element includes a second media item that is started.

42. A physical medium including information interpretable by a computing device, the information including
a structured playlist, the structured playlist including a set of playlist elements, each playlist element including at least one of (a) a media item, (b) a structured playlist, (c) a first set of playlist elements gleaned as a subset of a second set of playlist elements in a structured playlist.

43. A physical medium as in claim 42, including
a set of metadata associated with at least one playlist element;
whereby that metadata is associated with one or more media items within that playlist element.

44. A physical medium as in claim 43, including
a first set of metadata in association with a first playlist element;
a second set of metadata in association with a second playlist element;
the metadata in association with that second playlist element differing in type from the metadata in association with that first playlist element.

45. A physical medium as in claim 43, including
a first set of metadata in association with a first playlist element, that first set of metadata being dynamic or static in response to whether that playlist element is currently being performed;
a second set of metadata in association with a second playlist element, that second set of metadata being dynamic or static in response to whether that playlist element is currently being performed.

46. A physical medium as in claim 43, including
a first set of metadata in association with a first playlist element that is currently being performed, that first set of metadata including at least one type of dynamic information responsive to a progress of performing that first playlist element;
a second set of metadata in association with a second playlist element that is not currently being performed, substantially absent dynamic information about that second set of metadata responsive to a progress of performing that second playlist element.

47. A physical medium as in claim 42, wherein
at least two such media items are discernable using distinct senses.

48. A physical medium as in claim 42, wherein
each media item included in that structured playlist is associated with a status; and
that status includes information regarding at least two of: whether media items have been performed, are being performed, or are planned for performance.

49. A physical medium as in claim 48, wherein
those steps of presenting include distinctly representing a particular portion of the structured playlist, with the effect that the emphasized portion is more easily noticed.

50. A physical medium as in claim 42, wherein
the structured playlist elements are associated with an ordering;
that status includes information regarding at least two of: whether media items have been performed, are being performed, or are planned for performance.

51. A physical medium as in claim 50, including
an interface for a user to navigate within a structured playlist;
wherein the interface includes instructions interpretable by a computing device to change from a first media item currently being performed to a second media item, and adjusting the status of playlist elements between the first media item and the second media item in response thereto.

52. Apparatus including
an input port disposed for receiving information representative of at least a portion of a structured playlist, the structured playlist including a set of playlist elements, each playlist element including at least one of (a) a media item, (b) a collection of media items;
one or more output elements coupled to that input port, capable of conditionally presenting a particular set of those playlist elements responsive to a type of that particular set of those playlist elements, and capable of conditionally performing media items associated with that set of playlist elements in response to a status of each such media item; and
memory responsive to at least one of those output elements and disposed for maintaining a status of at least one of those media items.

53. Apparatus as in claim 52, wherein
at least one of those output elements conditionally presents a set of metadata in association with one or more media items within at least one playlist element.

54. Apparatus as in claim 53, wherein
that metadata includes a first set of metadata in association with a first playlist element and a second set of metadata in association with a second playlist element, that first set of metadata being dynamic or static in response to whether that first playlist element is currently being performed and that second set of metadata being dynamic or static in response to whether that second playlist element is currently being presented.

55. Apparatus as in claim 53, wherein
that metadata includes a first set of metadata in association with a first playlist element and a second set of metadata in association with a second playlist element, that first set of metadata including at least one type of dynamic information responsive to a progress of performing that first playlist element and for that second set of metadata, dynamic information responsive to a progress of performing that second playlist element not being substantially presented.

56. Apparatus as in claim 53, wherein
that metadata includes a first set of metadata in association with a first playlist element and a second set of metadata in association with a second playlist element;
wherein metadata selected for that second playlist element differs in type from metadata selected for that first playlist element.

57. Apparatus as in claim 52, wherein
at least one of those playlist elements is essentially without a definite end.

58. Apparatus as in claim 57, wherein
that output element conditionally interrupts, pauses, or otherwise ends at least one playlist element having essentially no definite end.

59. Apparatus as in claim 57, wherein
that output element is responsive to a condition by which at least one playlist element having essentially no definite end is interrupted, paused, or otherwise ended;
wherein that condition operates without substantial overview by a listener.

60. Apparatus as in claim 52, wherein
at least two such media items are discernable using distinct senses.

61. Apparatus as in claim 52, wherein
one or more of those output elements are capable of providing a representation substantially distinguishable in response to a type of that particular playlist element.

62. Apparatus as in claim 61, wherein
that representation substantially distinguishes between (a) individual media items, (b) collections of media items.

63. Apparatus as in claim 61, wherein
that representation substantially distinguishes between (a) mix albums, (b) other types of playlist elements.

64. Apparatus as in claim 61, wherein
that representation substantially distinguishes between at least two of (a) individual songs, (b) albums, (c) mix albums, (d) other types of playlist elements.

65. Apparatus as in claim 52, wherein
the presented portion of a structured playlist includes only a portion of at least one selected playlist element.

66. Apparatus as in claim 52, wherein
the presented portion of a structured playlist includes only a selected subset of playlist elements.

67. Apparatus as in claim 52, wherein
the structured playlist elements are associated with an ordering;
that status includes information regarding at least two of: whether media items have been performed, are being performed, or are planned for performance;
conditionally presenting includes maintaining a status of at least one particular playlist element, and changing that status from those planned for performance to those being performed when that particular playlist element includes a media item that is started.

68. Apparatus as in claim 67, wherein
that output element conditionally alters a location for presentation of that particular playlist element in response to a change in its status.

69. Apparatus as in claim 67, wherein
that output element conditionally alters that ordering of at least a portion of that structured playlist, with the effect that the steps of performing are intended to perform that structured playlist in a changed order.

70. Apparatus as in claim 67, wherein
in response to a change in status of that particular playlist element, that output element conditionally presents that particular playlist element distinctly from other playlist elements.
